(19) United States
(12) Patent Application Publication
(10) Pub. No.: US 2012/0078925 A1
(43) Pub. Date: Mar. 29, 2012

(54) SEARCHING WITHIN LOG FILES

(75) Inventors: Noam Behar, Haifa (IL); Oma Raz-Pelleg, Haifa (IL); Moran Shochat, Zichron Ya'akov (IL); Yaakov Yaari, Haifa (IL); Aviad Zlotnick, Mitzpeh Netofah (IL)

(73) Assignee: International Business Machines Corporation, Armonk, NY (US)

(21) Appl. No.: 12/890,755

(22) Filed: Sep. 27, 2010

(51) Int. Cl. G06F 17/30

(52) U.S. Cl. 707/755; 707/E17.069

(57) ABSTRACT

A search tool may search a text file for entries matching one or more search criterions. The search tool may parse the file into entries. Entries may be parsed into lines and fields. A search criterion may define possible content in two or more fields and relationship between the two or more fields. The search criterion may be defined based on an exemplary entry of the text file, such as for example based on a selection of fields of the exemplary entry by a user.

### BACKGROUND

The present disclosure relates to searching log files in general, and to searching for text within log files without utilizing a format of the log files, in particular.

Searching through text files, such as log files, may be a complex and time consuming task. For example, field support personnel, such as technicians, system personnel and the like, analyze text files to detect errors and in order to fix problems in computerized devices. The text files may be logs, traces, dumps or the like. The text files may be generated by hardware components, software components or the like. Each file may be associated with a different format and may include multiple line heterogeneous entries. Moreover, the format of these entries and of the text files in general changes often as the underlying hardware or software changes.

The task of searching through such files may be time consuming and hence expensive. Some of the common tasks are structured: for example, in a log file that has entries structured as a table of events, each field support engineer may want to find all rows where the first column contains the word “X” in the second line and the fourth column contains the word “Y” in the third line. Though they can mark different text areas for editing purposes, it is not possible to use the selections as a search query.

Some tools enable searching in text files, also referred herein as log files. Searching for a predefined string is possible. In some cases, searching for a predefined format, defined for example by a regular expression, may also be possible, but requires understanding of the format of the log file and of how regular expressions are defined. The drawback of utilizing regular expression is that regular expression is a language that must be acquired. It may be error prone and time consuming, and each text editor might support different regular expressions syntax. Even a highly trained user might struggle with defining a regular expression, especially if it is intended to span over multiple lines.

However, regular expressions alone might not suffice. For example, a field support engineer may want to simultaneously look for multiple patterns in entries. This has advantages such as saving time and allowing the engineers to keep their train of thought during the analysis process. Because the entries may be heterogeneous, the location of the same pattern may vary in different entries. Moreover, the relative order between the patterns may change.

### BRIEF SUMMARY

One exemplary embodiment of the disclosed subject matter is a computer-implemented method for searching in a text file, the method comprising: parsing the text file into entries based on a predetermined line separator, wherein each entry comprises an entry identifier; for at least one entry of the entries, parsing the entry into lines and fields based on a predetermined field separator and based on the predetermined line separator; receiving an indication of a search criterion based on the at least one entry, wherein the search criterion comprises at least a first field and a second field; wherein the search criterion defines a relationship between the first field and the second field in respect to a number of fields in between the first and second fields and in respect to a number of lines between the first and second fields; and searching, by a computer, the text file for an entry matching the search criteria, wherein the searching is performed in respect to a storage device retaining the text file.

Another exemplary embodiment of the disclosed subject matter is a computerized apparatus for searching in a text file, the computerized apparatus having a processor and a storage device; the computerized apparatus comprising: a text file obtainer operative to obtain the text file; a file parsing module operative to parse the text file into entries based on a predetermined line separator and based on an entry identifier; entry parsing module operative to parse an entry determined by the file parsing module into lines and fields, wherein the parsing module is operative to parse the entry based on a predetermined field separator and based on the predetermined line separator; a search criterion defining module configured to define a search criterion based on an indication of a search criterion in respect to an entry that is parsed by the entry parsing module, wherein the search criterion comprises at least a first field and a second field; wherein the search criterion defines a relationship between the first field and the second field in respect to a number of fields in between the first and second fields and in respect to a number of lines between the first and second fields; and a search module operative to search the text file obtained by the text file obtainer for an entry matching the search criterion.

Yet another exemplary embodiment of the disclosed subject matter is a computer program product for searching in a text file, the computer program product comprising: a non-tangible computer readable medium; a first program instruction for parsing the text file into entries based on a predetermined line separator, wherein each entry comprises an entry identifier; a second program instruction for parsing at least one entry into lines and fields based on a predetermined field separator and based on the predetermined line separator; a third program instruction for receiving an indication of a search criterion based on the at least one entry, wherein the search criterion comprises at least a first field and a second field; wherein the search criterion defines a relationship between the first field and the second field in respect to a number of fields in between the first and second fields and in respect to a number of lines between the first and second fields; a fourth program instruction for searching the text file for an entry matching the search criteria; and wherein the first, second, third and fourth program instructions are stored on the non-tangible computer readable medium.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIG. 2 shows a block diagram of a search tool, in accordance with some exemplary embodiments of the disclosed subject matter;

FIG. 3 shows a flowchart diagram of a method, in accordance with some exemplary embodiments of the disclosed subject matter; and

FIG. 4 shows an illustration of displays and user interfaces, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to search a text file for entries that match one or more patterns. Another technical problem is to provide an interface for defining the patterns to be searched for. Yet another technical problem is to perform the search in a heterogeneous text file comprising entries of multiple different formats. Yet another technical problem is to search for entries matching the pattern without utilizing a format of the entries.

One technical solution is to define a search criterion based on a relation between two or more fields of an entry. The relation may be defined based on a number of fields and/or lines between the two or more fields. The fields may be determined based on standard delimiters, such as new line character as a line delimiter and one or more consecutive white characters (e.g., a space, a tab, and the like) as the field delimiter. In some exemplary embodiments, an entry may match the pattern in case the entry comprises fields matching text in accordance with the text of the two or more fields of the search criterion, wherein a relation between the fields is the same as that between the two or more fields of the search criterion. Another technical solution is to separate between entries based on an identifier, such as a timestamp, a unique ID, or the like. The solution may utilize an identification of the identifier in order to be able to distinguish between two entries. Yet another technical solution is to define using the relation a text, a format, or the like to which a text of a field should correlate. Yet another technical solution is to perform the search in respect to a plurality of search criterions. The search result may indicate which of the search criterions is matched by each entry. Yet another technical solution is to provide a tabular display of an exemplary entry and enable a user to indicate a search criterion using the tabular display.

One technical effect of utilizing the disclosed subject matter is to provide a user friendly interface for defining search criterions which may be utilized by a user to define and perform complex searches. The user may not be familiar with any formal language defining consecutive character strings, such as regular expressions. Another technical solution is to perform a search on a log file in which entries have different formats and define the search criterion in a manner that is indifferent of the specific format. In some exemplary embodiments, a first entry may be printed to the log file by a first component and a second entry may be printed to the log file by a second component. The first and second components may not utilize the same format. For example, the second component may be developed by a different developer than that of the first component. As another example, the second component may be a second version of the first component. In such exemplary embodiments, the disclosed subject matter provides the surprising effect of utilizing the same search criterion to locate entries printed by either of the two components. Yet another technical effect is to determine a search criterion based on an example entry within the log file. Yet another technical effect is to enable a technician to point to an entry and to locate similar entries within the log file.

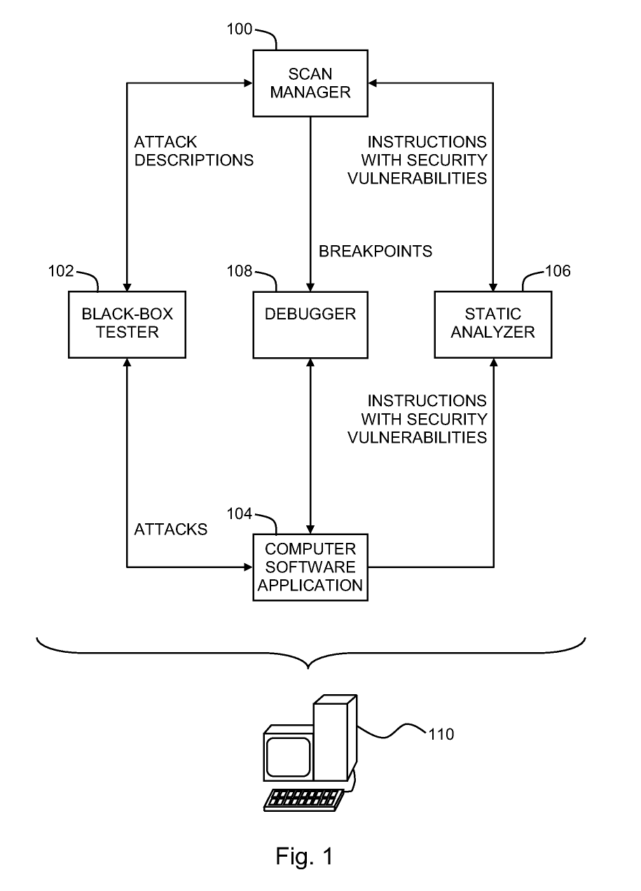

Referring now to FIG. 1 showing a computerized environment in which the disclosed subject matter is used, in accordance with some exemplary embodiments of the subject matter. A computerized environment 100 may comprise a search tool 110.

In some exemplary embodiments, the search tool 110 may be configured to search within a log file 130 for entries matching a search criterion. The search tool 110 may be a computerized device, implemented in hardware, software, firmware, combination thereof or the like.

In some exemplary embodiments, the search tool 110 may be operately coupled to a storage 120, such as a hard disk, a memory chip, a Flash disk, a Random Access Memory (RAM), a storage server, a remote storage, or a similar storage device. The storage 120 may retain the log file 130 such as for example created during an execution of a computerized device or one of its components. The log file 130 may be a text file comprising any number of entries. The entries may be heterogeneous of their format. The entries may have a hierarchy. For example, an entry may comprise one or more sub-entries. It will be noted that the log file 130 may be any form of text file that comprises entries. The disclosed subject matter is not limited to searching within files containing logged events.

In some exemplary embodiments, the user 140 may utilize a Man-Machine Interface (MMI) 145, such as a terminal, to interact with the search tool 110. The user 140 may provide indications useful for defining the search criterion. The user 140 may review search results. The user 140 may provide input useful for parsing the log file 130, such as a line separator (also referred to as a line delimiter), a field separator (also referred to as a field delimiter), a format of an entry identifier, or the like.

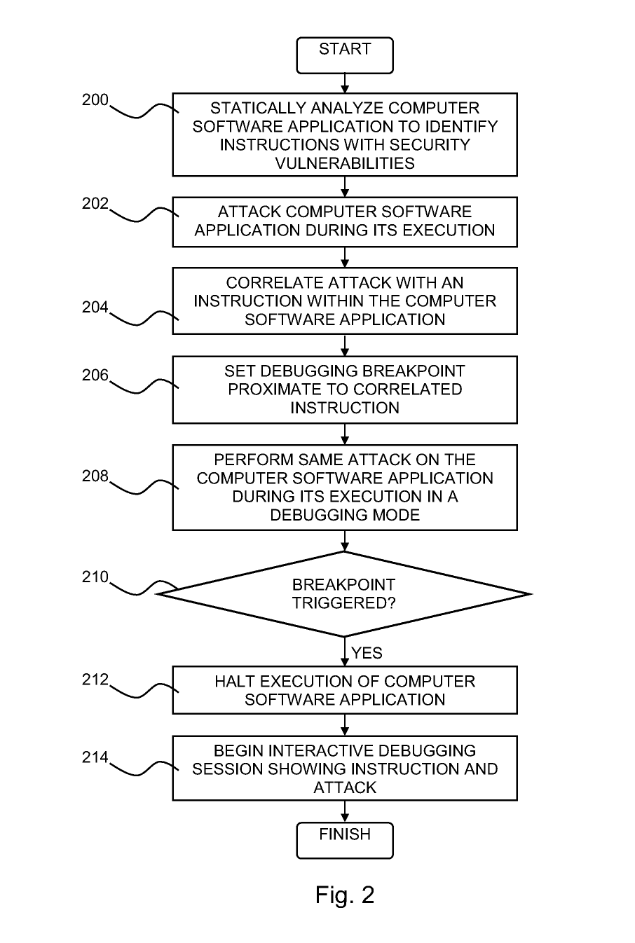

Referring now to FIG. 2 showing a block diagram of a search tool, in accordance with some exemplary embodiments of the disclosed subject matter. A search tool 200, such as 110 of FIG. 1, may be configured to search within a text file, such as log file 130 of FIG. 1.

In some exemplary embodiments, a text file obtainer 210 may be configured to obtain a text file. The text file may be obtained from a storage, such has 120 of FIG. 1.

In some exemplary embodiments, a file parsing module 220 may be configured to parse the text file obtained by the text file obtainer 210 into entries. In some exemplary embodiments, the file parsing module 220 may identify an entry by identifying an entry identifier. For example, in case a timestamp is an identifier, a format of the identifier may be determined, such as “dd:dd:dddd” (two digits followed by a colon, followed by two digits, followed by a colon, followed by four digits). The file parsing module 220 may be configured to determine a line beginning an entry in response to detecting an identifier in the line. In some exemplary embodiments, multiple components may be useful for detecting an identifier. In some exemplary embodiments, the identifier may indicate an ending of an entry or the like. In some exemplary embodiments, sub-entries may also be identified using different identifiers. It will be noted that the identifier may appear in the first line of the entry and not necessarily as the first element or in the beginning of that line. The disclosed subject matter is capable of handling such identifiers.

In some exemplary embodiments, the log file may exhibit some form of variability in the way it is broken into entries, i.e., in the definition of the entry identifier. Thus, in order to be independent of the log format, the file parsing module 220 may utilize a plurality of alternative entry identifiers. In some exemplary embodiments, in case one of the alternative entry identifiers is matched, an entry may be indicated. In some exemplary embodiments, the alternative entry identifiers may be defined explicitly as a set of separate entry identifiers. In some exemplary embodiments, the alternative entry identifiers may be defined using an abstract format to be matched by a text of the entry that correlates to one of a plurality of formats associated with the abstract format. The abstract format may be defined by a user, predetermined and selected by the user, or the like. For example, a “date” abstract format may be matched by a plurality of date formats, such as “dd.dd.dd”, “dd/dd/dd”, “dd.dd.dddd”,“www dd, dddd” and the like. In some exemplary embodiments, the user may indicate that the entry identifier comprises a abstract format, a format, a text, a combination thereof or the like. For example, the user may input the word ‘date’ to indicate that any standard form of date may be matched in the entry identifier. In some exemplary embodiments, other predetermined abstract formats may be ‘numeric’, ‘scientific’, ‘percent’, ‘text’ and the like. In some exemplary embodiments, the entry identifier may comprise a combination of formats such as for example ‘date, numeric API’ which may be matched by a text that begins with a date followed by a comma, followed by a numeric number and followed by the exact text “API”.

In some exemplary embodiments, the file parsing module 220 may parse the text file into entries based on a partial match of the entry identifier. In some exemplary embodiments, a text that is within a predetermined measurement of similarity to the format defined by the entry identifier may be considered as matching the entry identifier. The measurement of similarity may indicate a number of deletions, insertions, replacement or the like of a single word or a single character within the entry identifier that would render the parsed text to match the entry identifier. In some exemplary embodiments, the measurement of similarity may be measured as a percentage of deletions, insertions, replacement or the like out of the total number of words, characters or the like. In some exemplary embodiments, the measurement of similarity may be measured in other manners. In some exemplary embodiments, a predetermined minimal measurement of similarity may be determined, such as 90%.

In some exemplary embodiments, a file parsing module 220 may determine a line of the text file based on a predetermined line separator, such as a new line character. In some exemplary embodiments, a line separator determinator 291 may be used to determine the line separator. It will be noted that in many cases, line separators are defined uniformly per operating system.

In some exemplary embodiments, an entry parsing module 230 may be configured to parse an entry, such as an entry identified by the file parsing module 220, into fields and lines. The parsing may be performed based on predetermined separators such as the line separator and a field separator. In some exemplary embodiments, the field separator may be defined as a character, such as ‘:’, as a format, such as one or more consecutive white characters, or the like. In some exemplary embodiments, the entry may be parsed into a matrix, where each cell of the matrix comprises a content of a field and wherein each line of the matrix corresponds to a different line of the entry. It will be noted that though not all lines may have the same number of fields, adding null cells at the end of the lines may be done in order to produce a matrix that correctly corresponds to the entry.

In some exemplary embodiments, a search criterion defining module 240 may be configured to define a search criterion. The search criterion may be defined based on an indication provided by a user, such as 140 of FIG. 1. The indication may be provided in respect to an entry of the text file. For example, the user may indicate cells of a matrix determined by the entry parsing module 230, and that corresponds to an entry of the text file. The user may, therefore, provide an indication of a search criterion based on an exemplary entry. In some exemplary embodiments, the search criterion may comprise two or more fields of the entry. A relationship between the two or more fields of the entry may be defined, such as by determining the number of fields and lines in between the fields. In respect to a matrix that corresponds to the entry, the distance between cells of the matrix may be determined. In some exemplary embodiments, a first field may be utilized as an origin (e.g., origin in a X-axis and Y-axis). For example, the up-most left-most cell may be defined as the origin and each other cell that correspond to a field of the search criterion may be defined based on a distance from the origin. In some exemplary embodiments, the search criterion may further include a text comprised by a portion of the two or more fields. The search criterion may indicate that an entry that matches the search criterion comprises fields having text that correlates to text of the two or more fields of the search criterion. The text may be, for example, the same as comprised by a field of the search criteria, corresponding to a format that correlates to the text of the field of the search criterion or the like. In some cases, a user may indicate the format. In other cases, an automated procedure may be performed to determine the format based on one or more exemplary strings.

A search criteria may comprise a first field having the text “a”, a second field having the text “b” and a third field having the text “c”. A distance between the first field and the second field may be determined. For example: two lines and two fields. Coordinates may be utilized to represent this information (e.g., (2,2)). A distance between the first field and the second field may be determined. For example: one line and two field to the left of the first field. Coordinates (1,−2) may be utilized to represent this information. An entry in which there are three fields that are spaced apart in the same manner ((2,2) and (1,−2)). and in which the content of the fields is the “a”, “b” and “c” accordingly, may be considered as matching the search criterion. In some exemplary embodiments, whether an entry matches the search criterion may not be influenced by the content of other fields of the entry.

In some exemplary embodiments, a plurality of search criterions may be determined by the search criterion defining module 240. In some exemplary embodiments, each search criterion may be independent of each other. Fields of different search criterions may overlap, be in the same line, the same column, or the like.

In some exemplary embodiments, a search module 250 may be configured to search for one or more entries within the text file that match one or more search criterions. In some exemplary embodiments, the search module 250 may match an entry to all search criterions defined by the search criterion defining module 240. In some exemplary embodiments, the search module 250 may be configured to search for an entry that matches at least one of the search criterions defined by the search criterion defining module 240.

In some exemplary embodiments, the search module 250 may utilize a parsed text file, such as parsed by the file parsing module 220 into entries. The search module 250 may utilize parsed entries, such as parsed by the entry parsing module 230 into lines and fields. In response to matching a first field of the search criterion to a field in the parsed entry, the search module 250 may check whether other fields in the parsed entry that are located in relative places to the field, based on the relationship defined by the search criterion between the first field and other fields, match a content in correlation with the search criterion. For example, the first field may be the up-most left-most field. The fields of the parsed entry may be iterated over by the search module 250 to determine a match to the first field. In response to a match in the first field other matches in other fields are checked. In response to determining a match in the other fields—the entry may be deemed as matching the search criterion. In case the other fields do not match—the search module 250 may continue to iterate over the parsed entry to check for other possible matches of the first field. In some exemplary embodiments, several search criterions may be checked in respect to the first field.

In some exemplary embodiments, a result display 260 may be configured to display a search result determined by the search module 250. The search result may indicate one or more entries that match the searched criterions defined by the search criterion defining module 240. In some exemplary embodiments, a matching of fields within each entry may be indicated, such as for example using a background color, a highlight, a different font or the like. In some exemplary embodiments, for each search criterion a different indication may be used. For example, one color may be used to indicate matching a first criterion and a second color may indicate matching a second criterion. In some exemplary embodiments, the result list may comprise an indication of which search criterion is matched by each entry. For example, a column associated with a search criterion may be utilized to indicate whether the search criterion is matched by a respective entry. The result display 260 may be configured to provide a screenshot, a graphical display, a printout, or similar indication for a user, such as 140 of FIG. 1. The result display 260 may utilize an I/O module 205 to provide the indication to the user.

In some exemplary embodiments, a user interface module 270 may provide a user, such as 140 of FIG. 1, an interface to the search tool 200. In some exemplary embodiments, the user interface module 270 may be configured to provide a tabular view of a parsed entry. The tabular view may comprise of rows that correspond to lines of the entry and columns that separate between fields within a line. In some exemplary embodiments, the user interface module 270 may be response to a selection by a user of field in the tabular view. The selection may be translated into an indication to the search criterion defining module 240 to utilize the selected field in a search criterion. In some exemplary embodiments, a first selection may be utilized for a first criterion whereas a second selection may be utilized for a second criterion. In some exemplary embodiments, a selection by the user may indicate an entry to be displayed in the tabular view. For example, the user may select an entry to be used to define one or more search criterions.

In some exemplary embodiments, an entry identifier determinator 280 may be configured to determine an entry identifier. The entry identifier may be determined based on an indication by the user, such as a text defining the format of the entry identifier, a text defining an abstract format of the entry identifier or the like. In some exemplary embodiments, the entry identifier determinator 280 may provide the user with a list of possible identifiers, such as predetermined formats known to sometimes be identifiers such as timestamps of various formats, predetermined strings, predetermined expression or the like. In some exemplary embodiments, the user may provide a format for the entry identifier, such as using regular expression, using one or more exemplary identifiers, or the like.

In some exemplary embodiments, the entry identifier determinator 280 may be configured to determine the entry based on the text file. The user may select a plurality of entry identifiers from the text file of the alternative entry identifiers. The entry identifier determinator 280 may determine common portion of the alternative entry identifiers and variable portion of the alternative entry identifiers. The entry identifier determinator 280 may determine, based on the common and variable portions determine an abstract entry identifier. For example, a first entry identifier “22.8.10 API” and a second entry identifier “23.08.2010 API” may be determined to be represented by an abstract format “date API” as the common section API remains unchanged and the variable portion represents a date. In some exemplary embodiments, a plurality of variable portions and/or common portions may be exist.

In some exemplary embodiments, a line separator determinator 291 and a field separator determinator 292 may determine a line/field separator to be utilized by the search tool in parsing the text file. The determinators 291 and 292 may utilize predetermined separators, standard separators or the like. In some exemplary embodiments, the determinators 291 and 292 may be responsive to an input from the user of the separators utilized by the text file.

it will be noted that although the user may provide separators utilized by the text file, the format of the text file is not required by the search tool 200. For example, the user may not be required to indicate how many fields are there in each line, or which field is followed by another field.

The storage device 207 may be a Random Access Memory (RAM), a hard disk, a Flash drive, a memory chip, or the like. The storage device 207 may retain the text file obtained by the text file obtainer 210, a parsed version of the text file and/or entries, the search criterion determined by the search criterion defining module 240, the identifier or separator determined by either of the determinators 280, 291, 292, or the like.

In some exemplary embodiments of the disclosed subject matter, the search tool 200 may comprise an Input/Output (I/O) module 205. The I/O module 205 may be utilized to provide an output to and receive input from a user, such as 140 of FIG. 1.

In some exemplary embodiments, the search tool 200 may comprise a processor 202. The processor 202 may be a Central Processing Unit (CPU), a microprocessor, an electronic circuit, an Integrated Circuit (IC) or the like. The processor 202 may be utilized to perform computations required by the search tool 200 or any of it subcomponents.

In some exemplary embodiments, components of the search tool 200 may be implemented in software, hardware, firmware or the like. For example, the search module 250 may be implemented by a software code retained in the storage device 207 and by the processor 202 performing computation in accordance with the software code.

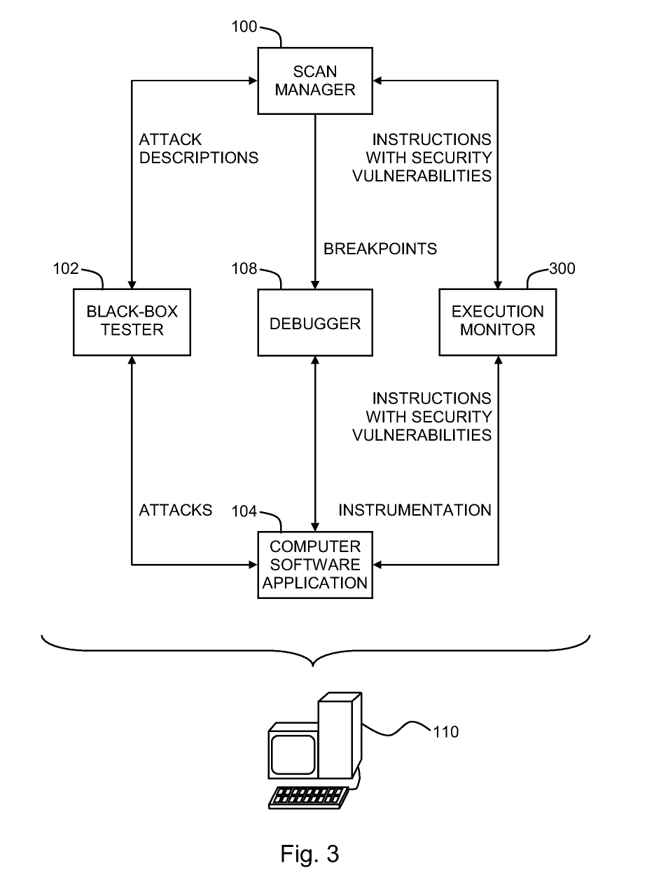

Referring now to FIG. 3 showing a flowchart diagram of a method in accordance with some exemplary embodiments of the disclosed subject matter.

In step 300, a text file may be obtained. The text file may be obtained by a text file obtainer, such as 210 of FIG. 2.

In step 310, an entry identifier may be determined. The entry identifier may be determined by an entry identifier determinator, such as 280 of FIG. 2.

In step 320, the text file may be parsed into entries. The text file may be parsed by a file parsing module, such as 220 of FIG. 2.

In step 330, an entry may be parsed into lines and fields. The entry may be selected by a user, such as 140 of FIG. 1. The entry may be parsed by an entry parsing module, such as 230 of FIG. 2. In some exemplary embodiments, a plurality of entries may be parsed.

In step 340, a tabular view of the parsed entry may be displayed or otherwise provided to the user. The tabular view may be determined by a user interface module, such as 270 of FIG. 2. The tabular view may be provided using an I/O module, such as 205 of FIG. 2.

In step 350, indications, such as selections of fields, may be received from a user. The indications may be useful in defining a search criterion according to the disclosed subject matter. The indications may be received using the I/O module and/or the user interface module.

In step 360, one or more search criterions may be determined based on the indications received in step 350. Each search criterion may comprise a format or a string to be comprised in fields of an entry. The fields of the entry have a predetermined number of lines and field between them, based on the indications received in step 360. The search criterions may be determined by a search criterion defining module, such as 240 of FIG. 2.

In step 370, the text file may be searched for entries matching at least one of the search criterions. In some exemplary embodiments, only entries that match all of the search criterions are searched for. The search may be performed by a search module, such as 250 of FIG. 2.

In step 380, search result may be displayed. The search result may be, for example, a list of entries that matched one or more search criterions. In some exemplary embodiments, the search result may be displayed by highlighting portions of entries in the text file. The search result may be displayed by a result display, such as 260 of FIG. 2.

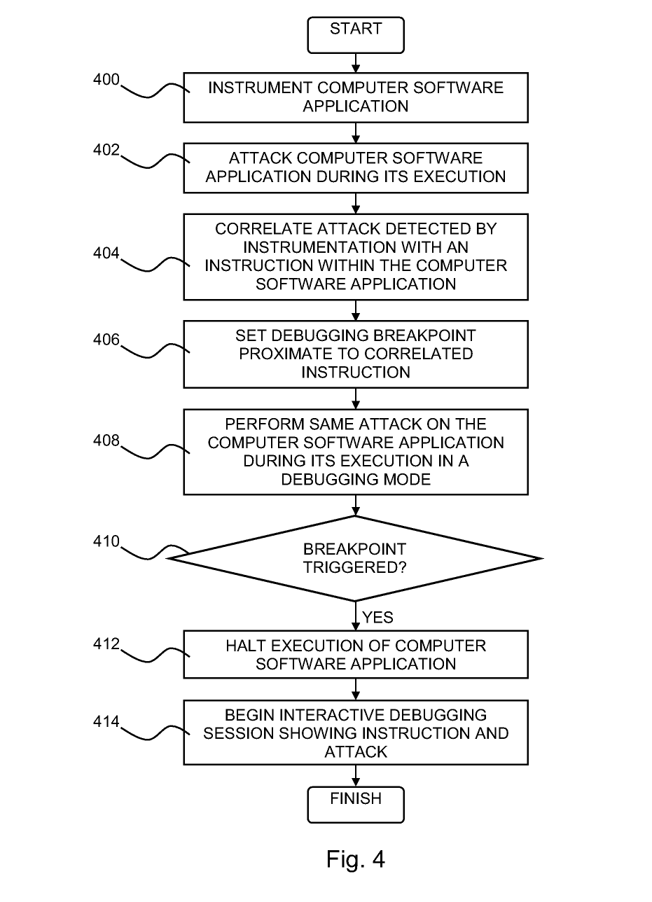

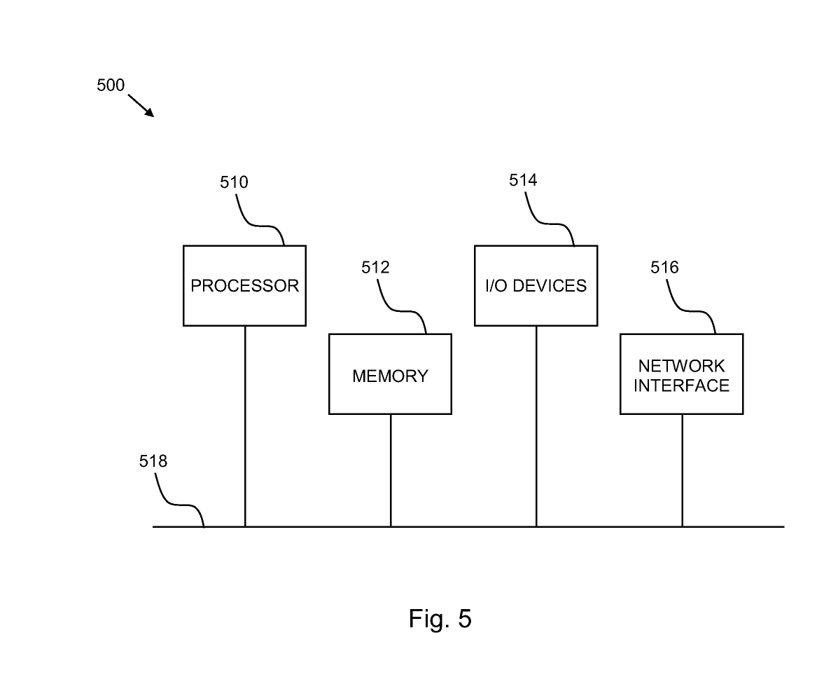

Referring now to FIG. 4 showing an illustration of displays and user interfaces, in accordance with some exemplary embodiments of the disclosed subject matter.

A first display 400 illustrates a display of a text file. A user may indicate an entry 410 to be used as a basis for defining one or more search criterions.

A second display 420 may illustrate a tabular view of the entry 410. The entry 410 is displayed in a table or a similar display. A line in the table corresponds to a line in the text file. A line is partitioned into columns, separating different fields of a line. In some exemplary embodiments, there may be a line that comprises a smaller number of fields than other lines, empty cells or other null cells may be added to the line. The tabular view may be displayed or otherwise provided to a user, such as 140 of FIG. 1. The user may select one or more fields to be used in a search criterion.

A third display 440 illustrates indications of selections by the user. Cells 442, 444, 446 and 448 may be selected to be used in a first search criterion. Cells 452, 454, 456 may be selected to be used in a second search criterion. The first search criterion may be defined as an entry that comprises the text “0-2:” in a first field, the text “3-5:” in a second filed that is located one line below the first field and in the same column as the first field, a text “A5F60401” in a third field that is in the same line as the first field and two cells to the right of the first field, and a text “GA505070” in a fourth field that is in the line below the first field and four cells to the right of the first field. In some exemplary embodiments, a different field may be used as an origin for defining relations. In some exemplary embodiments, coordinates may be determined in respect to the origin. In some exemplary embodiments, some fields may be defined in respect to a first field while others may be defined in respect to a second field. In some exemplary embodiments, the content of the fields may be used as an exact search criterion (i.e., the same text should appear in an entry of the text file) or as a format (i.e., similar text should appear in the entry). The format may be defined manually or automatically.

In some exemplary embodiments, a relation between different search criterions is not taken into account while searching for matching entries. For example, although in the third display 440 there is one line that parts between a first search criterion (comprising cells 442, 444, 446, and 448) and a second search criterion (comprising cells 452, 454, 456) a matching entry may comprise both of the search criterions where a different number of lines parts between them. For example, an entry 468 matches the first search criterion in the first and second lines and the second search criterion in the fifth line.

A fourth display 460 illustrates a search result display. The text file may be presented with an indication of entries that match one or more search criterions. In some exemplary embodiments, entries that do not match any search criterion are not displayed in the fourth display 460. In other exemplary embodiments, entries that do not match any search criterion are displayed. In some exemplary embodiments, the display 460 shows a parsed view of entries. In some exemplary embodiments, an entry identifier is displayed in the beginning of each entry. It will be noted that the entry identifier may not be comprised in the beginning of the entry (for example, consider entry 410 which displays the timestamp in the fourth field of the first line). In some exemplary embodiments, the first line of the entry may be considered as part of the entry. In other exemplary embodiments, the first line may be omitted from the parsed entry (e.g., the entry 462). In yet other exemplary embodiments, the first line may be provided in the beginning of the entry to indicate it is useful for identification of the entry.

In some exemplary embodiments, a matched entry 462 matches both search criterions. Corresponding indications, such as coloring of matching fields, may be displayed in the fourth display 460. In some exemplary embodiments, a matched entry 464 matches one search criterion. It will be noted that as opposed to the entry 410 which is used to define the search criterion, the matched entry 464 comprises a greater number of fields. The relation between “0-2:”, “A5F60401”, “3-5:”, “GA505070” is the same as in the entry 410, and therefore the matched entry 464 matches the first search criterion. In some exemplary embodiments, a matched entry 466 matches the second search criterion. In some exemplary embodiments, the matched entry 468 matches both search criterions.

In some exemplary embodiments, other displays may be used to show the search result.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method for searching in a text file, the method comprising:
parsing the text file into entries based on a predetermined line separator, wherein each entry comprises an entry identifier;
for at least one entry of the entries, parsing the entry into lines and fields based on a predetermined field separator and based on the predetermined line separator;
receiving an indication of a search criterion based on the at least one entry, wherein the search criterion comprises at least a first field and a second field; wherein the search criterion defines a relationship between the first field and the second field in respect to a number of fields in between the first and second fields and in respect to a number of lines between the first and second fields; and
searching, by a processor, the text file for an entry matching the search criteria, wherein said searching is performed in respect to a storage device retaining the text file.

2. The computer-implemented method of claim 1, wherein the search criterion is further configured to define a string to appear in a field matching the first field.

3. The computer-implemented method of claim 1, further comprises displaying, by a display device, a search result; wherein the search result comprises a plurality of entries that match the search criterion.

4. The computer-implemented method of claim 3, further comprises receiving an indication of a second search criteria; and wherein said searching comprises searching for an entry matching either the search criterion or the second criterion.

5. The computer-implemented method of claim 4, wherein said displaying comprises displaying in respect to each entry of the plurality of entries an indication on whether the entry matches the search criteria, the second criteria, or both the search criterion and the second criterion.

6. The computer-implemented method of claim 3, further comprises receiving an indication of a second search criteria; and wherein said searching comprises searching for an entry matching either or both of the search criterion and the second criterion.

7. The computer-implemented method of claim 3, wherein the search criterion comprises a third field; and wherein the search criterion further defines a relationship between the first field and the third field.

8. The computer-implemented method of claim 3,
wherein a first portion of the text file is associated with a first format and a second portion of the text file is associated with a second format;
wherein the at least one entry is associated with the first format;
wherein at least a portion of the plurality of entries is associated with the second format.

9. The computer-implemented method of claim 1, wherein the search criterion is further configured to define a string format to appear in a field matching the first field.

10. The computer-implemented method of claim 1, further comprises displaying to a user the at least one entry in a tabular view; and wherein said receiving the indication comprises determining fields in the tabular view that are selected by the user.

11. The computer-implemented method of claim 1, wherein the entry separator is a new line character; and wherein the field separator is one or more consecutive white characters.

12. The computer-implemented method of claim 1, wherein the entry identifier is a timestamp.

13. The computer-implemented method of claim 1, wherein the entry identifier is an abstract format representative of a plurality of alternative formats.

14. The computer-implemented method of claim 13, further comprises determining the abstract format based on a plurality of entry identifiers, wherein the abstract format correlates to each of the plurality of entry identifiers.

15. The computer-implemented method of claim 13, wherein said parsing the text file into entries comprises identifying an entry identifier based on the abstract format, wherein the entry identifier is within a predetermined measurement of similarity to the abstract format.

16. The computer-implemented method of claim 1 further comprises receiving an indication of an entry identifier for an entry in the text file.

17. The computer-implemented method of claim 1, wherein the entry identifier defines an entry; and wherein an entry comprises one or more sub-entries.

18. A computerized apparatus for searching in a text file, the computerized apparatus having a processor and a storage device; the computerized apparatus comprising:
a text file obtainer operative to obtain the text file;
a file parsing module operative to parse the text file into entries based on a predetermined line separator and based on an entry identifier;
entry parsing module operative to parse an entry determined by said file parsing module into lines and fields, wherein said parsing module is operative to parse the entry based on a predetermined field separator and based on the predetermined line separator;
a search criterion defining module configured to define a search criterion based on an indication of a search criterion in respect to an entry that is parsed by said entry parsing module, wherein the search criterion comprises at least a first field and a second field; wherein the search criterion defines a relationship between the first field and the second field in respect to a number of fields in between the first and second fields and in respect to a number of lines between the first and second fields; and
a search module operative to search the text file obtained by said text file obtainer for an entry matching the search criterion.

19. The computerized apparatus of claim 18, wherein said search module is configured to search for an entry wherein:
a third field comprises text in accordance with the first field;
a fourth field comprises text in accordance with the second field; and
a relationship between the third field and the fourth field is the relationship between the first field and the second field.

20. The computerized apparatus of claim 18, a result display operative to display a search result comprising of entries within the text file that match the search criterion.

21. The computerized apparatus of claim 20, wherein said search module is operative to search for two or more search criteria, wherein each of the two or more search criterion is defined by said search criterion defining module; and wherein said result display is operative to display for each of the entries which of the two or more search criterion the is matched.

22. The computerized apparatus of claim 18 further comprises:
a user interface module operative to display an entry in a tabular view, based on a lines and fields determined by said entry parsing module;
wherein said user interface module is further operative to receive selections of fields, by a user; and
wherein said search criterion defining module is operative to utilize the selection of fields to define the search criterion.

23. The computerized apparatus of claim 22 further comprises an entry identifier determinator operative to determine the entry identifier.

24. The computerized apparatus of claim 23 further comprises:
a line separator determinator operative to determine the predetermined line separator; and
an entry separator determinator operative to determine the predetermined field separator.

25. A computer program product for searching in a text file, the computer program product comprising:
a non-tangible computer readable medium;
a first program instruction for parsing the text file into entries based on a predetermined line separator, wherein each entry comprises an entry identifier;
a second program instruction for parsing at least one entry into lines and fields based on a predetermined field separator and based on the predetermined line separator;
a third program instruction for receiving an indication of a search criterion based on the at least one entry, wherein the search criterion comprises at least a first field and a second field; wherein the search criterion defines a relationship between the first field and the second field in respect to a number of fields in between the first and second fields and in respect to a number of lines between the first and second fields;
a fourth program instruction for searching the text file for an entry matching the search criteria; and
wherein said first, second, third and fourth program instructions are stored on said non-tangible computer readable medium.
